(19) United States
(12) Patent Application Publication
(10) Pub. No.: US 2013/0007217 A1
(43) Pub. Date: Jan. 3, 2013

(54) SYSTEMS, METHODS, AND APPARATUS FOR COORDINATING UTILITY METER PROGRAM FILES

(75) Inventors: Hyoung Jhang, Duluth, GA (US); Michael Patrick Thesing, Tucker, GA (US); Jing Chen, Atlanta, GA (US)

(73) Assignee: GENERAL ELECTRIC COMPANY, Schenectady, NY (US)

(21) Appl. No.: 13/170,489

(22) Filed: Jun. 28, 2011

(51) Int. Cl. G06F 15/16

(52) U.S. Cl. 709/219

(57) ABSTRACT

Systems, methods, and apparatus for coordinating the execution of program files by utility meters and/or the receipt of program file responses are provided. A command associated with a program file to be executed by a utility meter may be received by the utility meter via a network. The command may be formatted in accordance with an Internet-based protocol. The utility meter may process the received command. Additionally, the program file associated with the command may be configured to access one or more tables stored by the utility meter and conforming to an American National Standards Institute (ANSI) C12.19 standard.

### CROSS-REFERENCE TO RELATED APPLICATION

This application is related to co-pending patent application Ser. No. ______ (Attorney Docket 19441-0603), filed Jun. 28, 2011, and entitled “Systems, Methods, and Apparatus for Utility Meter Configuration.”

### FIELD OF THE INVENTION

Embodiments of the invention relate generally to utility meters, and more specifically to systems, methods, and apparatus for coordinating the execution of program files by utility meters and/or the receipt of program file responses.

### BACKGROUND OF THE INVENTION

Utility meters, such as power meters, are utilized in a wide variety of different applications to monitor and/or communicate utility usage information. In order to configure utility meters and to collect information from utility meters, information is typically written to and read from a wide variety of stored configuration tables. The tables typically conform to the American National Standards Institute (“ANSI”) C12.19 standard. Accordingly, communication with the utility meters is conventionally governed by other ANSI standards, such as the ANSI C12.18 and ANSI C12.22 standards.

With the introduction of new software packages for utility meters, utility meter configuration can now be accomplished via Internet-based communication protocols. For example, the integration of the Smart Energy Profile (“SEP”) version 2.0 or other Representational State Transfer (“REST”) architectures into utility meters permits Hypertext Transfer Protocol (“HTTP”) and Efficient Extensible Markup Language Interchange (“EXI”) communication via an Internet Protocol (“IP”) layer. With these new communication protocols, there exists an opportunity for improved systems, methods, and apparatus for configuring utility meters. Additionally, there exists an opportunity for improved systems, methods, and apparatus for coordinating the execution of program files by utility meters and/or the receipt of program file responses.

### BRIEF DESCRIPTION OF THE INVENTION

Some or all of the above needs and/or problems may be addressed by certain embodiments of the invention. Embodiments of the invention may include systems, methods, and apparatus for coordinating the execution of program files by utility meters and/or the receipt of program file responses. According to one embodiment of the invention, there is disclosed a method. A command associated with a program file to be executed by a utility meter may be received by the utility meter via a network. The command may be formatted in accordance with an Internet-based protocol. The utility meter may process the received command. Additionally, the program file associated with the command may be configured to access one or more tables stored by the utility meter and conforming to an American National Standards Institute (ANSI) C12.19 standard.

According to another embodiment of the invention, there is disclosed a utility meter. The utility meter may include at least one network interface, at least one memory, and at least one processor. The at least one network interface may be configured to receive a command associated with a program file to be executed by the utility meter, the command formatted in accordance with an Internet-based protocol. The at least one memory may be configured to store computer-executable instructions. The at least one processor may be configured to access the at least one memory and execute the computer-executable instructions to process the received command, wherein the program file is configured to access one or more tables stored by the utility meter and conforming to an American National Standards Institute (ANSI) C12.19 standard.

According to yet another embodiment of the invention, there is disclosed a method. A head end device associated with an Automated Metering Infrastructure may generate a command associated with a program file to be executed by a utility meter. The command may be formatted in accordance with an Internet-based protocol. The head end device may transmit the generated command to the utility meter, and the utility meter may be configured to process the command. Additionally, a program file associated with the command may be configured to access one or more tables stored by the utility meter and conforming to an American National Standards Institute (ANSI) C12.19 standard.

Additional systems, methods, apparatus, features, and aspects are realized through the techniques of various embodiments of the invention. Other embodiments and aspects of the invention are described in detail herein and are considered a part of the claimed invention. Other embodiments, features, and aspects can be understood with reference to the description and the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one example system that facilitates utility meter configuration and/or the management of utility meter program files and/or program file responses, according to an illustrative embodiment of the invention.

FIG. 2 is a flow diagram of an example method for accessing a table associated with a utility meter, according to an illustrative embodiment of the invention.

FIG. 3 is a flow diagram of an example method for managing a program file executed by a utility meter and/or accessing program file response information, according to an illustrative embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems, methods, and apparatus for facilitating utility meter configuration and/or program file management. In certain embodiments of the invention, a schema for facilitating the communication of commands associated with configuration tables and/or program files may be provided. The schema may utilize Internet communication capabilities of the utility meter to facilitate reading and writing of data formatted in accordance with other protocols. For example, the schema may facilitate reading and writing of tables formatted in accordance with an ANSI C12.19 standard. As another example, the schema may facilitate the communication of commands associated with program files that access utility meter tables formatted in accordance with an ANSI C12.19 standard. A wide variety of different Internet-based communication protocols may be utilized as desired in various embodiments of the invention, such as a Hypertext Transfer Protocol (“HTTP”), an Applicability Statement 2 (“AS2”) protocol, an Efficient Extensible Markup Language Interchange (“EXI”) protocol, and/or a Transport Layer Security (“TLS”) protocol. Additionally, in certain embodiments, a suitable software program may be integrated into the utility meter to facilitate Internet-based communications. For example, software that utilizes a Representational State Transfer (“REST”) format, such as a Smart Energy Profile (“SEP”) version 2.0 specification, an AS2 specification, or another suitable specification, may be integrated into the utility meter, and HTTP, AS2, and/or EXI capabilities of the REST format or specification may be utilized. As another example, other suitable Extensible Markup Language (“XML”)-based messaging schemes may be integrated into the utility meter.

According to an aspect of the invention, the schema may define a plurality of commands that may be processed in order to access ANSI formatted tables and/or that may be processed to manage program tiles that access ANSI formatted tables. In other words, new resources may be provided that take advantage of Internet-based communications while permitting the reading and writing of ANSI formatted tables. In this regard, dedicated metering protocols, such as the ANSI C12.18 protocol, the ANSI C12.22 protocol, and the Device Language Message Specification Companion for Specification Energy Metering (“DLMS/COSEM”) protocol, may be avoided. Additionally, enhanced communication security and access control mechanisms may be provided. For example, an HTTP-based protocol, such as an AS2 protocol or an EXI protocol, may facilitate a wide variety of security functions, such as key management, certificate management, and/or payload authentication. Additionally, as a result of utilizing an HTTP-based protocol, communications between a utility meter and a head end device may utilize an infrastructure that has relatively lower data transmission costs than traditional communications networks utilized by utility meters.

In one example embodiment of the invention, a command associated with one or more utility meter tables, such as utility meter configuration tables, may be communicated to a utility meter. For example, a command may be communicated to the utility meter by a head end device, such as an Advanced Metering Infrastructure (“AMI”) head end device. According to an aspect of the invention, the command may be formatted in accordance with an Internet-based protocol, such as an HTTP, AS2, or TLS protocol. Additionally, in certain embodiments, the command may be formatted in accordance with a suitable specification that facilitates XML-based messaging, such as an SEP specification or another REST-compliant specification or format. According to an aspect of the invention, the command may be associated with the access of a meter table formatted in accordance with an ANSI C12.19 standard. In other words, an Internet-based command may be communicated to the utility meter, and the utility meter may process the received command in order to access a table formatted in accordance with an ANSI C12.19 standard.

A wide variety of suitable table access commands may be utilized as desired in various embodiments of the invention. For example, commands to read information from a table or write information to a table may be utilized. Additionally, commands to receive identifying information associated with various utility meter devices and/or listings of available tables (e.g., standard tables, manufacturer tables, pending tables, etc.) may be utilized. In certain embodiments, a command may include a Uniform Resource Identifier (“URI”), and the URI may be utilized to identify a type associated with the command (e.g., a read command, a write command, etc.) and/or a utility meter device associated with the command.

Additionally, systems, methods, and apparatus for facilitating the management of program files executed by a utility meter and/or responses to the program files are disclosed. In one example embodiment of the invention, a command associated with a program file to be executed by a utility meter may be communicated to the utility meter. For example, a command may be communicated to the utility meter by a head end device, such as an AMI head end device. According to an aspect of the invention, the command may be formatted in accordance with an Internet-based protocol, such as an HTTP, AS2, or TLS protocol. Additionally, in certain embodiments, the command may be formatted in accordance with a suitable specification that facilitates XML-based messaging, such as an SEP specification or another REST-compliant specification or format. According to an aspect of the invention, the command may be associated with a program file configured to access one or more meter tables formatted in accordance with an ANSI C12.19 standard.

A wide variety of suitable program file commands may be utilized as desired in various embodiments of the invention. For example, commands to add a program file, modify a program file, delete a program file, and/or subscribe to a program file response generated based upon the execution of a program file may be utilized. Additionally, commands to receive identifying information associated with available program files, available program file responses, and/or altered or changed program files and/or program file responses may be utilized. In certain embodiments, a command may include a URI, and the URI may be utilized to identify a type associated with the command.

Various embodiments of the invention may include one or more special purpose computers, systems, and/or particular machines that facilitate utility meter configuration and/or program file communications. A special purpose computer or particular machine may include a wide variety of different software modules as desired in various embodiments. As explained in greater detail below, in certain embodiments, these various software components may be utilized to communicate and/or receive commands and/or process the commands to facilitate utility meter configuration, management of program files, and/or management of program file responses.

Certain embodiments of the invention described herein may have the technical effect of facilitating the configuration of utility meters. Additionally, certain embodiments may have the technical effect of facilitating the management, editing, and/or reading of utility meter configuration tables. Further, a schema utilized to facilitate configuration and/or table management may utilize an Internet-based protocol in order to ultimately access tables formatted in accordance with an ANSI C12.19 standard. In this regard, conventional dedicated metering protocols may be circumvented. As a result, reliable communication may be achieved, and communication security may be enhanced.

Various embodiments of the invention described herein may also have the technical effect of providing commands associated with program files that are executed by a utility meter. The program files may be configured to access one or more tables stored by the utility meter. A schema utilized to facilitate program file commands may utilize an Internet-based protocol in order to ultimately utilize program files configured to access tables formatted in accordance with an ANSI C12.19 standard. In this regard, conventional dedicated metering protocols may be circumvented. As a result, reliable communication may be achieved, and communication security may be enhanced.

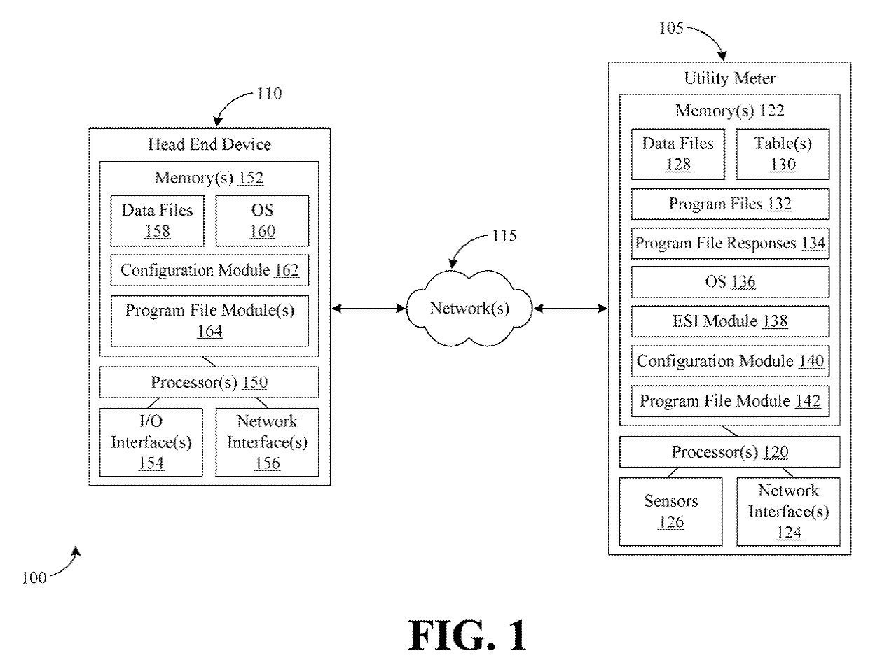

FIG. 1 is a block diagram of one example system 100 that facilitates utility meter configuration and/or the management of utility meter program files and/or program file responses, according to an illustrative embodiment of the invention. The system 100 illustrated in FIG. 1 may include a utility meter 105, a head end device 110, and/or one or more networks 115. The utility meter 105 may be configured to monitor utility usage for a structure, such as a residence or business. In certain embodiments, one or more configuration tables for the meter may control the monitoring and/or the storage of monitoring data, as well as other utility meter operations. Additionally, in certain embodiments, one or more program files may be executed by the utility meter to facilitate a series of table reads and/or writes, as well as the preparation of a program file response. According to an aspect of the invention, the head end device 110 may communicate configuration commands and/or program file-related commands to the utility meter 105 via the networks 115 utilizing an Internet-based protocol. The commands may be received and processed by the utility meter 105. In certain embodiments, the processing of the commands may result in the accessing of ANSI C12.19 tables and/or various program files that access the tables.

With reference to FIG. 1, the utility meter 105 may be any suitable utility meter that may be configured to receive commands and/or communicate messages or other communications, such as a suitable electrical meter, water meter, or gas meter. As such, the utility meter 105 may be configured to measure an amount of utility usage (e.g., electrical usage, etc.) supplied to an associated residence, business, or machine. In certain embodiments, the utility meter 105 may be a smart meter or an advanced meter configured to identify consumption in relatively greater detail than a conventional meter. For example, a smart power meter may facilitate real-time or near real-time readings, power outage notifications, and/or power quality monitoring.

The utility meter 105 may include any number of suitable computer processing components that facilitate the general operation of the meter 105 and/or the processing of received commands. Examples of suitable processing devices that may be incorporated into a utility meter 105 include, but are not limited to, application-specific circuits, microcontrollers, minicomputers, other computing devices, and the like. As such, the utility meter 105 may include any number of processors 120 that facilitate the execution of computer-readable instructions to control the operations of the utility meter 105 and the processing of received commands. By executing computer-readable instructions, the utility meter 105 may include or form a special purpose computer that facilitates the receipt of commands formatted in accordance with an Internet-based protocol and the processing of the received commands.

In addition to one or more processor(s) 120, the utility meter 105 may include one or more memory devices 122, one or more network interface devices 124, and/or one or more sensors 126. The one or more memory devices 122 or memories may be any suitable memory devices, for example, caches, read-only memory devices, random access memory devices, magnetic storage devices, etc. The one or more memory devices 122 may store data, executable instructions, and/or various program modules utilized by the utility meter 105, for example, data files 128, tables 130, program files 132, program file responses 134, an operating system (“OS”) 136, an Energy Services Interface (“ESI”) module 138, a configuration module 140, and/or a program file module 142. The data files 128 may include, for example, information associated with the operation of the utility meter 105, measurements and/or readings data collected by the utility meter 105, information associated with a monitored structure, information associated with the head end device 110, information associated with communicating with the head end device 110, information associated with the access and/or management of configuration tables, information associated with the management and/or execution of program files, and/or information associated with the management of program file responses.

The tables 130 may include any suitable tables associated with the utility meter 105 and/or various utility meter devices. These tables may include a wide variety of suitable information, such as utility meter identification data, configuration data, and/or data collected by the utility meter 105. Examples of suitable tables include, but are not limited to, standard tables that are specified by the ANSI C12.19 standard to be associated with utility meters, manufacturer tables that are defined by a manufacturer of the utility meter 105 and/or utility meter devices, and/or pending tables. In accordance with an aspect of the invention, one or more commands may be processed in order to facilitate table access. For example, table reads and/or writes may be performed to facilitate a wide variety of purposes, such as configuration of the utility meter 105 and/or utility meter devices. As another example, in certain embodiments, one or more tables may be accessed by one or more program files executed by the utility meter 105. For example, the execution of a program file may perform a series of table read and/or write requests.

The program files 132 may include any suitable instructions and/or sets of instructions that may be executed by the utility meter 105. In certain embodiments, the program files 132 may be configured to perform any number of table reads and/or writes during execution. For example, a program file 132 may be executed in order to identify measurements and/or monitor data collected by the utility meter 105. As another example, a program file may be executed to configure the utility meter 105 and/or a device associated with the utility meter. Certain program files 132 may be executed in order to produce or generate program file responses 134. The program file responses 134 may include any suitable data generated as a result of program file execution. In certain embodiments, a program file response 134 may be captured and stored for later retrieval by clients (e.g., the head end device 110, etc.) and/or communication to clients. For example, a program file response 134 may be captured in another program file and stored for later retrieval.

In certain embodiments of the invention, the utility meter 105 may include any number of software applications or modules that are executed to facilitate the operations of the utility meter 105. The software applications may include computer-readable instructions that are executable by the one or more processors 120. The execution of the computer-readable instructions may form a special purpose computer that facilitates the operations of the utility meter 105 as well as the processing of received commands. As an example of a software application, the utility meter 105 may optionally include an OS 136 that controls the general operation of the utility meter 105 and that facilitates the execution of additional software applications.

Additionally, in certain embodiments, the utility meter 105 may include an ESI module 138. The ESI module 138 may be a suitable software module configured to function as a Web server that receives and processes URIs and commands. In certain embodiments, the ESI module 138 may receive commands, such as Web service commands (e.g., HTTP, AS2, XML, and/or Simple Object Access Protocol commands) from the head end device 110, such as table access commands and/or commands associated with a program file, and the ESI module 138 may process the received commands. As desired, the ESI module 138 may map and/or translate received commands into a format that may be further processed by the utility meter 105. For example, Web service commands may be mapped into a format and/or protocol that may be utilized to access ANSI C12.19 tables. Although the ESI module 138 is described as a software module that is executed by the processors 120 of the utility meter 105, in certain embodiments, the ESI module 138 may be a separate device that is associated with the utility meter.

The configuration module 140 or configuration application may be a suitable software module configured to process table access commands. In operation, the configuration module 140 may receive a table access command. For example, a command output by the head end device 110 may be received. As another example, a command that has been processed by the ESI module 138 may be received. Once the command has been received, the configuration module 140 may process the command to facilitate a wide variety of different table accesses, such as table reads and/or table writes. In certain embodiments, a URI included in the command may be evaluated by the configuration module 140 in order to identify a type associated with the command and/or to identify a utility meter device associated with the command. According to an aspect of the invention, the command may be initially formatted in accordance with an Internet-based protocol. Further, the command may be processed by the configuration module 140 to facilitate access to a table formatted in accordance with an ANSI C12.19 standard.

A wide variety of different types of commands may be processed by the configuration module 140 as desired in various embodiments of the invention. Certain commands may be utilized to facilitate reading from tables and/or writing to tables. Other commands may be utilized to request information associated with available tables and/or devices associated with the utility meter 105. Table 1 below illustrates some example command formats that may be utilized in accordance with the invention; however, it will be appreciated that other commands may be utilized.

TABLE 1
Example Commands Associated with Table Access

| | | Operations |
|---|---|---|
| Resource | Description | Permitted |
| /mtr/{#}/dev | List devices available within a | GET |
| | meter | |
| /mtr/{#}/dev/{#} | Retrieve table categories | GET |
| | available within a device | |
| /mtr/{#}/dev/{#}/stbl | List standard tables | GET |
| /mtr/{#}/dev/{#}/stbl/{#} | Read and write a standard table | GET/PUT |
| /mtr/{#}/dev/{#}/mtbl | List manufacturer tables | GET |
| /mtr/{#}/dev/{#}/mtbl/{#} | Read and write a manufacturer | GET/PUT |
| | table | |
| /mtr/{#}/dev/{#}/ptbl | List pending tables | GET |
| /mtr/{#}/dev/{#}/ptbl/{#} | Read and write a pending table | GET/PUT |

As desired, each command may also be referred to as a URI. A received command may include a requested operation and a resource space associated with the requested operation. The resource space may include a wide variety of information, such as an identifier or address of the utility meter 105, an identifier or address of a utility meter device, an identifier of a table, an identifier of a table field to read and/or write to, and/or information to be written to a table field. For example, the command “GET/mtr/{#}/dev” may request a list of devices that exist within the utility meter 105. In response to the command, an EXI list of devices may be returned. As another example, the command “GET/mtr/{#}/dev/{#}/stbl” may request a list of standard tables associated with a utility meter device. The command “PUT/mtr/{#}/dev/{#}/stbl/{#}” may request a write operation on a standard table for a utility meter device. Other commands that may be generated, received, and/or processed will be readily apparent.

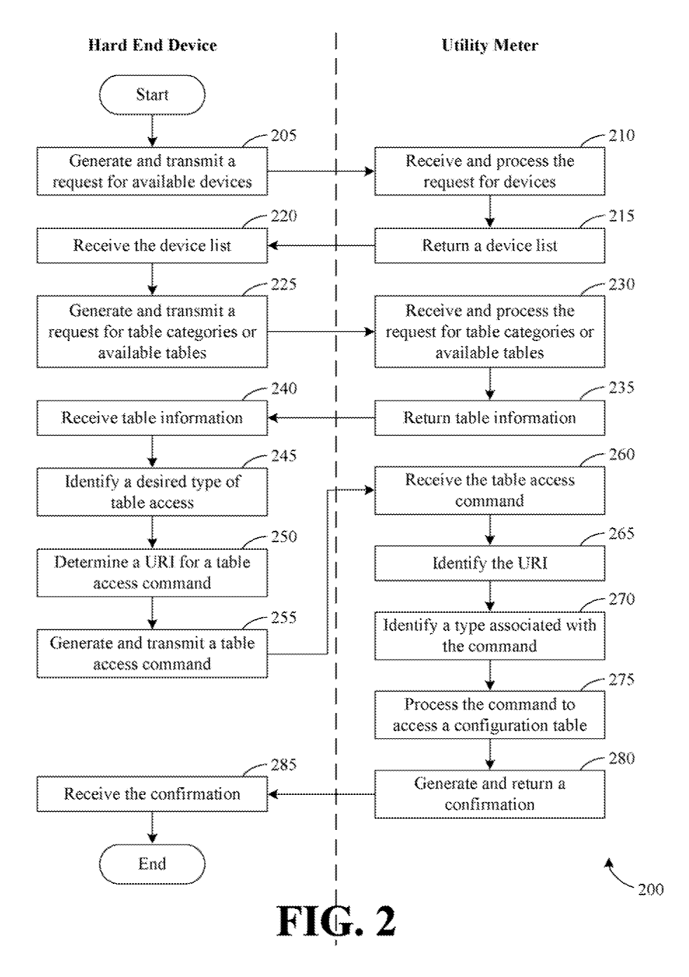

One example of the operations that may be performed by the configuration module 140 is described in greater detail below with reference to FIG. 2.

The program file module 142 or program file application may be a suitable software module configured to receive and process commands associated with program files and/or program file responses. In operation, the program file module 142 may receive a command associated with a program file. For example, a command output by the head end device 110 may be received. As another example, a command that has been processed by the ESI module 138 may be received. Once the command has been received, the program file module 142 may process the command to facilitate a wide variety of program file operations, such as the addition of a program file, the modification of a program file, the deletion of a program file, and/or the subscription to a program file response. In certain embodiments, a URI included in the command may be evaluated by the program file module 142 in order to identify a type associated with the command and/or to identify a device designated to execute a program file. According to an aspect of the invention, the command may be initially formatted in accordance with an Internet-based protocol. Further, the command may be associated with a program file that is configured to access one or more tables formatted in accordance with an ANSI C12.19 standard.

A wide variety of different types of commands may be processed by the program file module 142 as desired in various embodiments of the invention. Certain commands may be utilized to facilitate the addition, deletion, and/or modification of program files. Other commands may be utilized to request information associated with available program files and/or program file responses. Other commands may be utilized to facilitate subscribing to program file responses and/or deleting subscriptions. Yet other commands may be utilized to request and/or receive notification of changes to program file responses. Table 2 below illustrates some example command formats that may be utilized in accordance with the invention; however, it will be appreciated that other commands may be utilized. Additionally, while most of the commands are commands received and processed by a utility meter 105, certain commands may be communicated to a client (e.g., the head end device 110) by the utility meter 105. For example, a program file response change notification may be output by the utility meter 105.

TABLE 2
Example Commands Associated with Program Files

| | | Operations |
|---|---|---|
| Resource | Description | Permitted |
| /mtr/{#}/pf | List and add program files | GET/POST |
| /mtr/{#}/pf/{#} | Retrieve, update, and delete a | GET/PUT/DELETE |
| | program file | |
| /mtr/{#}/pfr | List available program file | GET |
| | responses | |
| /mtr/{#}/pfr/{#} | Retrieve and delete a program | GET/DELETE |
| | file response | |
| /mtr/{#}/pfr/sub | List and add subscriptions to | GET/POST/DELETE |
| | program file responses | |
| /mtr/{#}/pfr/sub/ | Retrieve and delete | GET/DELETE |
| {IPv6 Address 2} | subscriptions to program | |
| | file responses by Client | |
| | with Address 2 | |
| /ntfy | Notification of change to | POST |
| | program file response(s). Sent | |
| | to client with Address 2 | |

Similar to the table access commands, each command may also be referred to as a URI. A received command may include a requested operation and a resource space associated with the requested operation. The resource space may include a wide variety of information, such as an identifier or address of the utility meter 105, an identifier of a program file or program file response, an identifier of a program file response subscription, an identifier of a client device, and/or an address for a client device. For example, the command “POST/mtr/{#}/pf” may request the addition of a program file associated with the command. In response to the command, an EXI representation of a program file may be added. As another example, the command “POST/mtr/{#}/pfr/sub” may request the addition of a program file response subscription. The command “/ntfy” may be a command generated by the utility meter 105 to notify a client device or recipient of a change in a program file response. For example, a program file may be executed to collect monitoring data, and a client device may be notified of the updated monitoring data. Other commands that may be generated, received, and/or processed will be readily apparent.

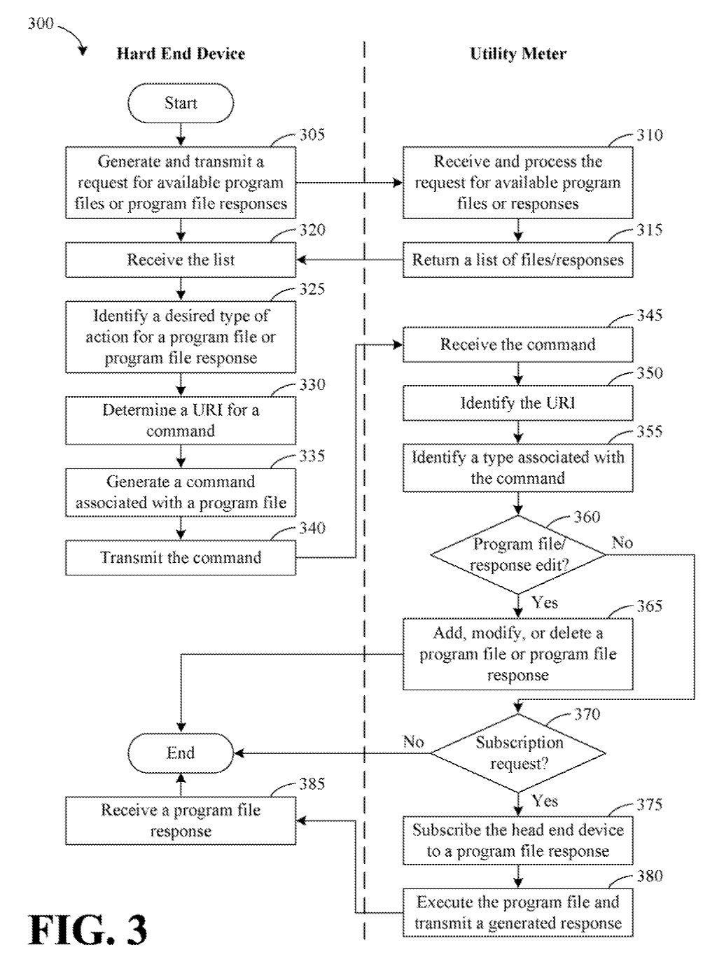

One example of the operations that may be performed by the program file module 142 is described in greater detail below with reference to FIG. 3.

In certain embodiments, the various commands that are processed by the utility meter 105 may be formatted in accordance with an Internet-based protocol, such as HTTP, AS2, and/or TLS. Additionally, in certain embodiments, the commands may be associated with a suitable XML-based messaging scheme. For example, a utility meter 105 may utilize a Smart Energy Program specification to facilitate the receipt, processing, and/or transmission of commands.

The one or more network interface devices 124 may facilitate connection of the utility meter 105 to any number of suitable networks and/or transmission means. Examples of suitable network interfaces include, but are not limited to, cellular interfaces, WiMAX interfaces, PLC and/or BPL interfaces, cable modem interfaces, digital subscriber line (“DSL”) interfaces, and/or any other suitable interfaces. As desired, any number of suitable communications cards, transceivers, transducers, adaptors, radios, and/or other devices may be utilized to interface the utility meter 105 to any number of suitable transmission networks, such as a network that facilitates Internet-based communications. In certain embodiments, communications devices and/or communications circuits (e.g., cards, transceivers, transducers, etc.) may be included, incorporated, or integrated into the utility meter 105. In other embodiments, communications devices and/or communications circuits may be external to the utility meter 105 and connected to the utility meter 105 via any number of suitable plugs, pins, wires, and/or other connections.

The one or more sensors 126 may include any suitable sensor devices configured to collect measurements data associated with the operation of the utility meter 105. For example, the sensors 126 may include voltage sensors, current sensors, variable ampere reactive sensors, flow sensors, and/or other suitable devices configured to collect readings and/or other measurements. In this regard, usage data may be collected by the utility meter 105 for processing and/or output.

With continued reference to FIG. 1, the head end device 110 may be any suitable device and/or system configured to communicate commands to (e.g., configuration commands, program file-related commands, etc.) and/or receive messages and/or information from any number of utility meters, such as the utility meter 105 described above. In certain embodiments, the head end device 110 may be a head end device associated with an Advanced Meter Infrastructure (“AMI”) network.

The head end device 110 may include any number of suitable computer processing components that facilitate the general operation of the head end device 110, the communication of commands to the utility meter 105, and/or the receipt of messages from the utility meter 105. Examples of suitable processing devices that may be incorporated into the head end device 110 include, but are not limited to, application-specific circuits, microcontrollers, minicomputers, personal computers, server computers, other computing devices, and the like. As such, the head end device 110 may include any number of processors 150 that facilitate the execution of computer-readable instructions to control the operations of the head end device 110. By executing computer-readable instructions, the head end device 110 may include or form a special purpose computer that facilitates the generation of commands that are communicated to utility meters for meter configuration, program file management, program file response management, and/or subscription to program file responses.

In addition to one or more processor(s) 150, the head end device 110 may include one or more memory devices 152, one or more input/output interface devices 154, and/or one or more network interface devices 156. The one or more memory devices 152 or memories may be any suitable memory devices, for example, caches, read-only memory devices, random access memory devices, magnetic storage devices, etc. The one or more memory devices 152 may store data, executable instructions, and/or various program modules utilized by the head end device 110, for example, data files 158, an operating system (“OS”) 160, a configuration module 162, and/or a program file module 164. The data files 158 may include, for example, information associated with the operation of the head end device 110, information associated with the utility meter 105, messages and/or measurements data collected from the utility meter 105, information associated with the generation of commands, information associated with program files and/or program file responses, and/or information associated with subscriptions to program file responses.

In certain embodiments of the invention, the head end device 110 may include any number of software applications or modules that are executed to facilitate the operations of the head end device 110. The software applications may include computer-readable instructions that are executable by the one or more processors 150. The execution of the computer-readable instructions may form a special purpose computer that facilitates the operations of the head end device 110 as well as the generation of various commands. As an example of a software application, the head end device 110 may include an OS 160 that controls the general operation of the head end device 110 and that facilitates the execution of additional software applications.

The configuration module 162 or configuration application may be a suitable software module configured to generate and/or direct the transmission of commands that access one or more utility meter tables and/or request information associated with utility meter tables. In operation, the configuration module 162 may access information associated with a utility meter and/or utility meter device, such as a utility meter and/or device address. As desired, the configuration module 162 may additionally determine information associated with a desired table associated with the utility meter, such as a desired configuration table. The configuration module 162 may then generate or prepare a command that facilitates table access, such as a read or write operation for a table, and the configuration module 162 may direct the communication of the command to the utility meter 105. Alternatively, the configuration module 162 may generate or prepare a command that requests information associated with available utility meter devices and/or available tables. In certain embodiments, the command may be formatted in accordance with an Internet-based protocol, such as HTTP, AS2, and/or TLS. For example, the command may take the form of a URI that includes a requested operation and/or a resource space. Once generated, the command may be transmitted or otherwise communicated to the utility meter 105 via one or more suitable networks, such as one or more packet-switching networks.

One example of the operations that may be performed by the configuration module 162 is described in greater detail below with reference to FIG. 2.

The program file module 164 or program file application may be a suitable software module configured to generate and/or direct the transmission of commands associated with program files and/or program file responses. Additionally, the program file module 164 may be configured to receive and process commands associated with program files and/or program file responses, such as notification commands associated with changes or modifications to program file responses. In operation, the program file module 164 may access information associated with a utility meter and/or utility meter device, such as a utility meter and/or device address. As desired, the program file module 164 may additionally determine information associated with a desired program file, program file response, and/or program file subscription. The program file module 164 may then generate or prepare a command that facilitates addition, modification and/or deletion of a program file, program file response, and/or response subscription, and the program file module 164 may direct the communication of the command to the utility meter 105. Alternatively, the program file module 164 may generate or prepare a command that requests information associated with available program files, program file responses, and/or program file response subscriptions. In certain embodiments, the command may be formatted in accordance with an Internet-based protocol, such as HTTP, AS2, and/or TLS. For example, the command may take the form of a URI that includes a requested operation and/or a resource space. Once generated, the command may be transmitted or otherwise communicated to the utility meter 105 via one or more suitable networks, such as one or more packet-switching networks.

One example of the operations that may be performed by the program file module 164 is described in greater detail below with reference to FIG. 3.

The one or more I/O interfaces 154 may facilitate communication between the head end device 110 and one or more input/output devices, for example, one or more user interface devices, such as a display, keypad, mouse, pointing device, control panel, touch screen display, remote control, microphone, speaker, etc., that facilitate user interaction with the head end device 110. In this regard, user commands may be received by the head end device 110. The one or more network interface devices 156 may facilitate connection of the head end device 110 to any number of suitable networks and/or transmission means. Examples of suitable network interfaces include, but are not limited to, cellular interfaces, WiMAX interfaces, PLC and/or BPL interfaces, cable modem interfaces, digital subscriber line (“DSL”) interfaces, and/or any other suitable interfaces. As desired, any number of suitable communications cards, transceivers, transducers, adaptors, radios, and/or other devices may be utilized to interface the head end device 110 to any number of suitable transmission networks, such as a network that facilitates Internet-based communications.

The one or more networks 115 may include any number of suitable networks that facilitate communications between the various components of the system 100, such as the head end device 110 and the utility meter 105. For example, the one or more networks 115 may include any number of suitable wide area networks, such as a cellular network, a broadband over power line network, a satellite-based network, a telephone network, a cable network, an Advanced Metering Infrastructure (“AMI”) network, a proprietary network associated with a utility service provider, and/or any network in which network traffic is shared among a plurality of devices.

As desired, embodiments of the invention may include a system 100 with more or less than the components illustrated in FIG. 1. The system 100 of FIG. 1 is provided by way of example only.

FIG. 2 is a flow diagram of an example method 200 for accessing a table associated with a utility meter, according to an illustrative embodiment of the invention. The method may be utilized in association with one or more utility meter systems, such as the system 100 illustrated in FIG. 1. In certain embodiments, the operations of the method 200 may be performed by at least one head end device and utility meter, such as the head end device 110 and the utility meter 105 illustrated in FIG. 1. The method 200 may begin at block 205.

At block 205, the head end device 110 may generate a command that includes a request for available devices associated with the utility meter 105. For example, the head end device 110 may utilize an Internet-based protocol to generate a command that includes a request for a listing of available device information. In certain embodiments, the command may include a URI and/or URI resource information. Additionally, the command may include address information for the utility meter 105. Once the command is generated, the command may be communicated to the utility meter 105 via any number of suitable networks, such as the networks 115 illustrated in FIG. 1.

The command may be received and processed by the utility meter 105 at block 210. For example, the utility meter 105 may receive the command and determine that the command includes a request for available devices. In one example embodiment, a URI included in the command may be evaluated in order to determine that the command includes a request for available devices. In response to the command, the utility meter 105 may prepare a listing of available utility meter devices, such as an EXI listing of devices, and the listing of available devices may be communicated to the head end device 110 at block 215. The listing of available devices may then be received and processed by the head end device 110 at block 220. In this regard, the head end device 110 may identify a wide variety of individual devices associated with the utility meter 105. In certain embodiments, each of the devices may be separately addressed. Additionally, as desired, a wide variety of respective tables may be associated with each of the devices.

At block 225, the head end device 110 may generate a command that includes a request for available table categories and/or available tables associated with the utility meter 105 or a utility meter device. Similar to the command that includes a request for available devices, an Internet-based protocol may be utilized to generate the command. As desired, the command may identify either the utility meter 105 or a desired device. Once the command has been generated, the command may be transmitted or otherwise communicated to the utility meter 105. The utility meter 105 may receive the command at block 230, and the utility meter 105 may process the command. During the processing of the command, the utility meter 105 may generate a listing, such as an EXI listing, of available table categories (e.g., standard tables, manufacturer tables, pending tables, etc.) and/or a listing of available tables (e.g., one or more standard tables, one or more manufacturer tables, one or more pending tables, etc.) associated with the utility meter 105 or a desired device. The table information may then be transmitted or otherwise communicated by the utility meter 105 to the head end device 110 at block 235. The table information may then be received and processed by the head end device 110 at block 240. In this regard, the head end device 110 may identify available table categories and/or available tables associated with the utility meter 105 and/or utility meter devices.

At block 245, the head end device 110 may identify or determine a desired type of table access. For example, the head end device 110 may determine whether a reading or writing access of a certain table is desired. In certain embodiments, the head end device 110 may determine whether a GET or a PUT command is desired. Once a type of table access has been identified, the head end device 110 may determine a URI for a table access command at block 250. The URI may include a wide variety of information, such as a command (e.g., GET, PUT, etc.), an address and/or identifying information for the utility meter 105 and/or utility meter device, a table identifier, one or more table field identifiers for fields to be read or written to, and/or information to be written to one or more table fields. Once the URI has been determined at block 250, a table access command may be generated at block 255, and the generated table access command may be transmitted or otherwise communicated to the utility meter 105.

The utility meter 105 may receive the table access command at block 260. At block 265, the utility meter 105 may identify a URI included in the table access command. Based upon an analysis of the URI, the utility meter 105 may identify a type associated with the table access command at block 270. For example, the utility meter 105 may determine whether the command is a read (or GET) command or a write (or PUT) command. At block 275, the utility meter may process the received command in order to access a desired table. For example, the utility meter 105 may analyze the command to identify a table to be accessed and/or fields to be accessed within the table. The utility meter 105 may then access the desired table and either read information from the table and/or write information to the table. According to an aspect of the invention, the table may be formatted in accordance with an ANSI C12.19 protocol. As a result, the utility meter 105 and/or an associated ESI may translate or otherwise process the command in order to facilitate access of the table.

In certain embodiments, the reading of and writing to tables may be utilized to facilitate configuration of the utility meter 105 and/or utility meter devices. For example, one or more configuration tables may be accessed, and the utility meter may be configured based at least in part upon the access. In other embodiments, the reading and/or writing to tables may be utilized to facilitate the collection of monitoring data and/or measurements data that has been gathered by the utility meter 105.

At block 280, which may be optional in certain embodiments of the invention, a return message associated with the processed command may be generated. In certain embodiments, the return message may include requested table read information. In other embodiments, the return message may include a confirmation that a read and/or write command has been completed or carried out by the utility meter 105. Once the return message has been generated, the return message may be transmitted or otherwise communicated to the head end device 110. The return message may then be received and processed by the head end device 110 at block 285.

The method 200 may end following block 285.

FIG. 3 is a flow diagram of an example method 300 for managing a program file executed by a utility meter and/or accessing program file response information, according to an illustrative embodiment of the invention. The method 300 may be utilized in association with one or more utility meter systems, such as the system 100 illustrated in FIG. 1. In certain embodiments, the operations of the method 200 may be performed by at least one head end device and utility meter, such as the head end device 110 and the utility meter 105 illustrated in FIG. 1. The method 300 may begin at block 305.

At block 305, the head end device 110 may generate a command that includes a request for available program files, program file responses, and/or program file response subscriptions that are associated with the utility meter 105. For example, the head end device 110 may utilize an Internet-based protocol to generate a command that includes a request for a listing of available program files, responses, and/or subscriptions. In certain embodiments, the command may include a URI and/or URI resource information. Additionally, the command may include address information for the utility meter 105 and/or for a device associated with a utility meter. Once the command is generated, the command may be communicated to the utility meter 105 via any number of suitable networks, such as the networks 115 illustrated in FIG. 1.

The command may be received and processed by the utility meter 105 at block 310. For example, the utility meter 105 may receive the command and determine that the command includes a request for available program files, program tile responses, and/or subscriptions. In one example embodiment, a URI included in the command may be evaluated in order to determine that the command includes a request for available program files, program file responses, and/or subscriptions. In response to the command, the utility meter 105 may prepare a listing of available program files, program file responses, or program file response subscriptions, such as an EXI listing of program files, and the listing may be communicated to the head end device 110 at block 315. The listing of program files, responses, or subscriptions may then be received and processed by the head end device 110 at block 320. In this regard, the head end device 110 may identify a wide variety of program file information associated with the utility meter 105.

At block 325, the head end device 110 may identify or determine a desired type of action associated with a program file or program file response. For example, the head end device 110 may determine whether a program file or program file response associated with the utility meter 105 will be retrieved, added, modified, or deleted. In certain embodiments, the head end device 110 may determine whether a GET, PUT, POST, or DELETE command is desired. As another example, the head end device 110 may determine whether a program file response will be subscribed to in order to receive program file response information, for example, in a periodic manner or based upon a change in the program file response. Once a type of desired action has been identified at block 325, the head end device 110 may determine a URI for a command at block 330. The URI may include a wide variety of information, such as a command (e.g., GET, PUT, etc.), an address and/or identifying information for the utility meter 105 and/or utility meter device, a program file and/or response identifier, and/or program file and/or response information. Once the URI has been determined at block 330, a program file command may be generated at block 335, and the generated command may be transmitted or otherwise communicated to the utility meter 105 at block 340.

The utility meter 105 may receive the command at block 345. At block 350, the utility meter 105 may identify a URI included in the received command. Based upon an analysis of the URI, the utility meter 105 may identify a type associated with the received command at block 355. For example, the utility meter 105 may determine whether the command is a command to add a program file or program file response, a command to retrieve a program file or program file response, a command to modify a program file or program file response, a command to delete a program file or program file response, or a command to subscribe to a program file response. At block 360, the utility meter 105 may determine whether the command is a command to retrieve, add, modify, or delete a program file or program file response. If it is determined at block 360 that the command is not a retrieve, add, modify, or delete command, then operations may continue at block 370 described below. If, however, it is determined at block 360 that the command is a retrieve, add, modify, or delete command, then operations may continue at block 365. At block 365, the command may be processed in order to retrieve and/or update program file and/or program file response information. For example, the utility meter 105 may analyze the command to identify a relevant program file, and the utility meter may communicate program file information to the head end device 110 in response to a GET command. As other examples, the utility meter 105 may add or delete a program file or program file response. Indeed, a wide variety of different modifications to program files and/or program file responses may be facilitated via the processing of suitable commands.

At block 370, the utility meter 105 may determine whether the received command is a command for a client (e.g., the head end device 110) to subscribe to a program file response. In other words, a determination may be made as to whether the command is a command to subscribe to a data file that is generated as a result of the execution of a program file. If it is determined at block 370 that the command is not a command for a program file response subscription, then operations of the method 300 may end. However, it will be appreciated that a command may be utilized in certain embodiments to delete an active or existing subscription, and such a command may be processed by the utility meter 105 to delete the subscription.

If it is determined at block 370 that the command is a command for a program file response subscription, then operations may continue at block 375. At block 375, the head end device 110 may be subscribed to a desired program file response. Following the subscription, a program file associated with the program file response (i.e., a program file that results in the generation of the program file response) may be executed at block 380. According to an aspect of the invention, the execution of the program file may result in a series of table read and/or write operations. For example, read and write operations for one or more tables formatted in accordance with an ANSI C12.19 protocol may be performed. As a result of the program file execution, a program file response may be generated and, in certain embodiments, the program file response may be transmitted or otherwise communicated to the head end device 110. The program file response may then be received and processed by the head end device 110 at block 385. As one example, a program file may be executed in order to generate a program file response that includes monitoring information for a household monitored by the utility meter 105. The program file response may then be transmitted to the head end device 110. In this regard, a wide variety of different types of information may be collected from utility meters by the head end device 110. As desired, information may be periodically collected (e.g., collected based upon a monthly execution of a program file, etc.) and/or collected based upon an alteration of a program file response.

The method 300 may end following either block 365, block 370, or block 385.

The operations described and shown in the methods 200, 300 of FIGS. 2 and 3 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 2 and 3 may be performed. For example, in certain embodiments, operations may be carried out by a utility meter 105 to notify the head end device 110 of alterations to a program file response. In other words, the utility meter 105 may generate a notification command that is transmitted to the head end device 110 based upon an identified change to a program file response. Indeed, a wide variety of different commands may be utilized in accordance with embodiments of the invention.

The invention is described above with reference to block and flow diagrams of systems, methods, apparatus, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method, comprising:
receiving, by a utility meter via a network, a command associated with a program file to be executed by the utility meter, the command formatted in accordance with an Internet-based protocol; and
processing, by the utility meter, the received command,
wherein the program file is configured to access one or more tables stored by the utility meter and conforming to an American National Standards Institute (ANSI) C12.19 standard.

2. The method of claim 1, wherein receiving a command comprises receiving a command formatted in accordance with a Representational State Transfer (REST) specification.

3. The method of claim 1, wherein processing the received command comprises:
identifying a Uniform Resource Identifier (URI) included in the received command;
identifying, based upon the URI, a type associated with the received command; and
processing the received command in accordance with the identified type.

4. The method of claim 1, wherein processing the received command comprises processing the received command to (i) add, (ii) modify, (iii) or delete the program file.

5. The method of claim 1, further comprising:
executing, by the utility meter, the program file in order to generate a program file response,
wherein processing the received command comprises processing the received command in order to subscribe a requesting device to the program file response.

6. The method of claim 1, wherein the command comprises a first command, and further comprising:
receiving, by a utility meter, a second command comprising a request for a list of available program files associated with the utility meter; and
processing, by the utility meter, the received second command in order to return the list of available program files in response to the received second command.

7. The method of claim 1, wherein the command comprises a first command, and further comprising:
receiving, by a utility meter, a second command comprising a request for a list of program file responses available for subscription; and
processing, by the utility meter, the received second command in order to return the list of program file responses.

8. A utility meter, comprising:
at least one network interface configured to receive a command associated with a program file to be executed by the utility meter, the command formatted in accordance with an Internet-based protocol;
at least one memory configured to store computer-executable instructions; and
at least one processor configured to access the at least one memory and execute the computer-executable instructions to process the received command, wherein the program file is configured to access one or more tables stored by the utility meter and conforming to an American National Standards Institute (ANSI) C12.19 standard.

9. The utility meter of claim 8, wherein the received command is formatted in accordance with a Representational State Transfer (REST) specification.

10. The utility meter of claim 8, wherein the at least one processor is configured to process the received command by executing the computer-executable instructions to:
identify a Uniform Resource Identifier (URI) included in the received command;
identify, based upon the URI, a type associated with the received command; and
process the received command in accordance with the identified type.

11. The utility meter of claim 8, wherein the at least one processor is configured to process the received command to (i) add, (ii) modify, (iii) or delete the program file.

12. The utility meter of claim 8, wherein the at least one processor is further configured to execute the computer-executable instructions in order to execute the program file and generate a program file response, and
wherein processing the received command comprises processing the received command in order to subscribe a requesting device to the program file response.

13. The utility meter of claim 8, wherein:
the command comprises a first command,
the at least one communications interface is further configured to receive a second command comprising a request for a list of available program files associated with the utility meter, and
the at least one processor is further configured to execute the computer-executable instruction to process the received second command in order to return the list of available program files in response to the received second command.

14. The utility meter of claim 8, wherein:
the command comprises a first command,
the at least one communications interface is further configured to receive a second command comprising a request for a list of program file responses available for subscription, and
the at least one processor is further configured to execute the computer-executable instruction to process the received second command in order to return the list of program file responses.

15. A method, comprising:
generating, by a head end device associated with an Automated Metering Infrastructure, a command associated with a program file to be executed by a utility meter, the command formatted in accordance with an Internet-based protocol;
transmitting, by the head end device to the utility meter, the generated command, wherein the utility meter is configured to process the command, and
wherein the program file is configured to access one or more tables stored by the utility meter and conforming to an American National Standards Institute (ANSI) C12.19 standard.

16. The method of claim 15, wherein generating a command comprises generating a command formatted in accordance with a Representational State Transfer (REST) specification.

17. The method of claim 15, wherein generating a command comprises:
identifying a type associated with the command;
determining, based at least in part upon the identified type, a Uniform Resource Identifier (URI) to be included in the command; and
generating the command based at least in part upon the determined URI.

18. The method of claim 15, wherein generating a command comprises generating a command to (i) add, (ii) modify, (iii) or delete the program file.

19. The method of claim 15, wherein generating a command comprises generating a command to subscribe to a program file response that is generated by the utility meter based upon the execution of the program file.

20. The method of claim 15, wherein the command comprises a first command, and further comprising:
generating, by the head end device, a second command comprising a request for one of (i) a list of available program files associated with the utility meter or (ii) a list of program file responses available for subscription;
transmitting, by the head end device to the utility meter, the generated second command; and
receiving, by the head end system from the utility meter, a second response to the second command,
wherein generating the first command comprises generating the first command based at least in part upon the received second response.
